(19) United States
(12) Patent Application Publication
(10) Pub. No.: US 2003/0165318 A1
(43) Pub. Date: Sep. 4, 2003

(54) Fiber optic device with multiple independent connecting regions and method for making same

(75) Inventor: Michael J. Petruziello, Chesterland, OH (US)

Correspondence Address: Patrick R. Roche, Esq., Fay, Sharpe, Fagan,, Minnich & McKee, LLP, 1100 Superior Avenue, 7th Floor, Cleveland, OH, 44114-2518, US

(73) Assignee: Quality Quartz to America, Inc.

(21) Appl. No.: 10/090,398

(22) Filed: Mar. 4, 2002

(51) Int. Cl. G02B 6/00

(52) U.S. Cl. 385/137

(57) ABSTRACT

A fiber optic device with connection regions in grooves of a substrate is provided. In one aspect, the device is a fiber optic coupler assembly and each groove receives fiber optic cables in the connection region to form couplings. In another aspect, each groove receives cables for connection to an electronic component. In one embodiment, the device includes a substrate with an elongate member having grooves along an exterior surface. In another embodiment, the device includes a substrate with multiple elongate members, each having a groove along an interior surface. A method for assembling the device includes: a) receiving cables in a first groove; b) connecting the fibers of each cable together in a connecting region of the first groove; c) selecting at least one cable from the first coupling and severing the selected cable(s); and d) performing steps a) through c) for a second groove.

### BACKGROUND OF INVENTION

The invention relates to fiber optic devices, such as fiber optic couplers. More particularly, the present invention relates to a fiber optic device with multiple independent connecting regions, each connecting region for receiving multiple optical fibers, and a method for making same. However, it is to be appreciated that the invention is also amenable to other applications.

A fiber optic coupler is a device that can distribute the optical signal (power) from, for example, one fiber among two or more fibers. A fiber optic coupler can also combine the optical signal from, for example, two or more fibers into a single fiber. Fiber optic couplers have been used in optical communications, optical sensors, and fiber optic gyroscopes. Fiber optic couplers can be either active or passive devices. The difference between active and passive couplers is that a passive coupler redistributes the optical signal without optical-to-electrical conversion. Active couplers are electronic devices that split or combine the signal electrically and use fiber optic detectors and sources for input and output.

FIG. 1 illustrates the design of a basic fiber optic coupler 10. A basic fiber optic coupler 10 has N input ports 12 and M output ports 14. N and M typically range from 1 to 64. The number of input ports 12 and output ports 14 vary depending on the intended application for the coupler 10. Types of fiber optic couplers 10 include optical splitters, optical combiners, X couplers, star couplers, and tree couplers.

An optical splitter is a passive device that splits the optical power carried by a single input fiber into, for example, two output fibers. The input optical power is normally split evenly between the two output fibers. This type of optical splitter is known as a Y-coupler. However, an optical splitter may distribute the optical power carried by input power in an uneven manner. An optical splitter may split most of the power from the input fiber to one of the output fibers. In this case, only a small amount of the power is coupled into the secondary output fiber. This type of optical splitter is known as a T-coupler, or an optical tap. An optical combiner is a passive device that combines the optical power carried by, for example, two input fibers into a single output fiber.

An X coupler combines the functions of the optical splitter and combiner. The X coupler combines and divides the optical power from, for example, the two input fibers between the two output fibers. Another name for the X coupler is the 2X2 coupler. Star and tree couplers are multiport couplers that have more than two input or two output ports. A star coupler is a passive device that distributes optical power from, for example, more than two input ports among several output ports. A tree coupler is a passive device that splits the optical power from one input fiber to more than two output fibers. A tree coupler may also be used to combine the optical power from more than two input fibers into a single output fiber. Star and tree couplers distribute the input power uniformly among the output fibers.

Generally, fiber optic couplers must prevent the transfer of optical power from one input fiber to another input fiber. Directional couplers are fiber optic couplers that prevent this transfer of power between input fibers. Many fiber optic couplers are also symmetrical. A symmetrical coupler transmits the same amount of power through the coupler when the input and output fibers are reversed.

There are several common techniques for fabricating passive fiber optic couplers. Some fiber optic coupler fabrication involves beam splitting using micro lenses or graded-refractive-index (GRIN) rods and beam splitters or optical mixers. These beam splitter devices divide the optical beam into two or more separated beams. Fabrication of fiber optic couplers may also involve twisting, fusing, and tapering together two or more optical fibers. This type of fiber optic coupler is a fused biconical taper coupler. Fused biconical taper couplers use the radiative coupling of light from the input fiber to the output fibers in the tapered region to accomplish beam splitting.

Fiber optic couplers are very sensitive to environmental influences because the optical material of which the optical fibers are made is very fragile. In addition, the coupling region is not provided with a jacket so adverse environments influence the quality of the optical material of the fiber optic coupler and/or the signals transmitted through the fiber optic coupler. Therefore, the optical signal processing performance of a fiber optic coupler in various environments typically depends upon the type of housing or package in which it is positioned for protection and on the method used to assemble the packaged fiber optic coupler. A problem with fused fiber optic couplers is latent failure of the coupler fiber or fibers inside the coupler enclosure or package due to stresses induced on the fiber from abuse such as pulls, tugs, jerks and yanks on the fiber from outside of the coupler package. The fused and tapered portions of the coupler where the transfer of optical power takes place is structurally weak and sensitive to such abuse, in addition to changes in environmental conditions.

Packaging techniques which have been used to protect the fiber optic coupler from such deleterious influences include the use of a slotted substrate, typically of quartz, silicon, sapphire, or ceramic material, as a protective covering and a support for the coupled region of a fiber optic coupler. In such an arrangement, the coupled region is typically placed within a central open portion of the substrate and epoxy is applied at the ends of the substrate to secure the optical fibers to the substrate.

Although end-to-end coupling devices for a plurality of fiber optics have been developed using a variety of differing approaches, including grooved block assemblies (see, for example, U.S. Pat. No. 5,402,512 to Jennings et al., U.S. Pat. No. 5,757,997 to Birrell et al., and U.S. Pat. No. 6,151,433 to Dower et al.), prior art disclosing an assembly for accommodating a large number of optical fiber couplers is very limited (see, for example, U.S. Pat. No. 4,514,057 to Palmer et al.), and no known prior art discloses an assembly accommodating multiple fiber optic couplers with substrates to support the fibers in the coupling region. In fact, most fiber optic couplers involve a relatively small number of fibers encased within a coupling package and are incapable of providing for a large number of independent optical couplers. Examples of these types of couplers and packages are shown in U.S. Pat. No. 6,085,001 to Belt, U.S. Pat. No. 6,148,129 to Pan et al., and U.S. Pat. No. 6,167,176 to Belt.

Heightening demands for fiber optic applications, particularly fiber optic communications, have led to demands for miniaturization, durability, and high reliability of fiber optic devices, including fiber optic couplers.

### SUMMARY OF THE INVENTION

Thus, there is a need for a fiber optic device capable of providing multiple independent connecting regions, each connecting region for receiving multiple optical fibers, the device having sufficient durability and reliability characteristics in view of fiber optic industry demands.

In one aspect of the invention, a fiber optic coupler assembly is provided. The fiber optic coupler assembly includes a substrate with at least two optically isolated grooves; at least two fiber optic cables disposed in each groove; and an enclosure for packaging the substrate and cables.

In another aspect of the invention, a fiber optic device is provided. The fiber optic device includes a substrate with at least two optically isolated grooves; at least one electronic component disposed in each groove; at least two fiber optic cables disposed in each groove; and an enclosure for packaging the substrate, electronic components, and cables.

In yet another aspect of the invention, a method for assembling a fiber optic coupler assembly is provided. The method includes the steps of: a) receiving at least two fiber optic cables in a first optically isolated groove of a substrate, each cable having a fiber jacket of the cable removed from a middle portion of the cable to expose an optical fiber; b) connecting the exposed optical fibers of each cable together in a connecting region of the first groove to form a first fiber optic coupling with at least four coupled fiber optic cables extending therefrom, each coupled fiber optic cable having a connection end joined in the first coupling and a lead end extending outward from the first groove; c) selecting at least one of the coupled fiber optic cables from the first coupling and severing the selected coupled fiber optic cable(s) from the first coupling; d) receiving at least two fiber optic cables in a second optically isolated groove of the substrate, each cable having a fiber jacket of the cable removed from a middle portion of the cable to expose an optical fiber, e) connecting the exposed optical fibers of each cable together in a connecting region of the second groove to form a second fiber optic coupling with at least four coupled fiber optic cables extending therefrom, each coupled fiber optic cable having a connection end joined in the second coupling and a lead end extending outward from the second groove; and f) selecting at least one of the coupled fiber optic cables from the second coupling and severing the selected coupled fiber optic cable(s) from the second coupling.

In still another aspect of the invention, a method for assembling a fiber optic device is provided. The method includes the steps of: a) receiving at least two fiber optic cables in a first optically isolated groove of a substrate, each cable having a connection end and a lead end, each cable having a fiber jacket removed from the connection end of the cable to expose an optical fiber within the cable, wherein at least one electronic component is disposed in the first groove; b) connecting the exposed optical fibers from the connection end of each cable to predetermined points on the electronic component(s) in a connecting region of the first groove; c) receiving at least two fiber optic cables in a second optically isolated groove of the substrate, each cable having a connection end and a lead end, each cable having a fiber jacket removed from the connection end of the cable to expose an optical fiber within the cable, wherein at least one electronic component is disposed in the second groove; and d) connecting the exposed optical fibers from the connection end of each cable to predetermined points on the electronic component(s) in a connecting region of the second groove.

Accordingly, one object of the invention is to provide a fiber optic device with multiple connecting regions. Each connecting region capable of receiving multiple optical fibers and, in one aspect, independent fiber optic couplings. An advantage of the invention is its contribution to miniaturization of fiber optic equipment.

### BRIEF DESCRIPTION OF DRAWINGS

The invention is described in more detail in conjunction with a set of accompanying drawings.

FIG. 1 is a block diagram of a prior art fiber optic coupler.

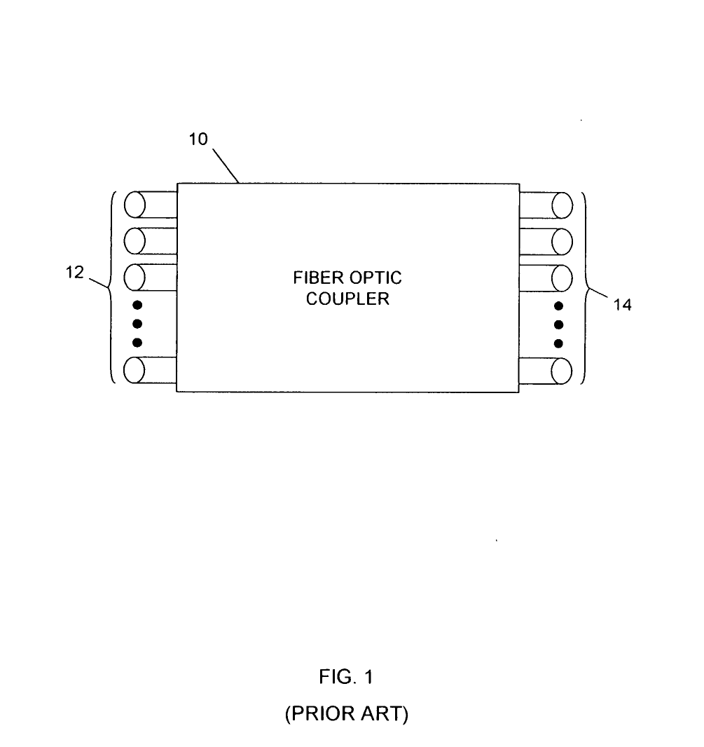

FIG. 2 provides geometric views of a substrate for a fiber optic device in one embodiment of the invention.

FIG. 3 provides geometric views of a substrate for a fiber optic device in another embodiment of the invention.

FIG. 4 provides geometric views of a substrate for a fiber optic device in still another embodiment of the invention.

FIG. 5 provides geometric views of a substrate for a fiber optic device in yet another embodiment of the invention.

FIG. 6 provides geometric views and a cross-sectional view of a fiber optic device using a substrate in the embodiment shown in FIG. 2.

FIG. 7 provides geometric views of a substrate for a fiber optic device in one embodiment of the invention.

FIG. 8 provides geometric views of a substrate for a fiber optic device in another embodiment of the invention.

FIG. 9 provides geometric views and a cross-sectional view of a fiber optic device using the substrate in the embodiment shown in FIG. 7.

### DETAILED DESCRIPTION

While the invention is described in conjunction with the accompanying drawings, the drawings are for purposes of illustrating exemplary embodiments of the invention and are not to be construed as limiting the invention to such embodiments. It is understood that the invention may take form in various components and arrangements of components, and in various steps and arrangements of steps beyond those provided in the drawings and associated description. Within the drawings, like reference numerals denote like elements. Additionally, similar items are identified from drawing to drawing with reference numbers bearing the same two least significant digits with the most significant digit changing from drawing to drawing to indicate a minor difference between the items.

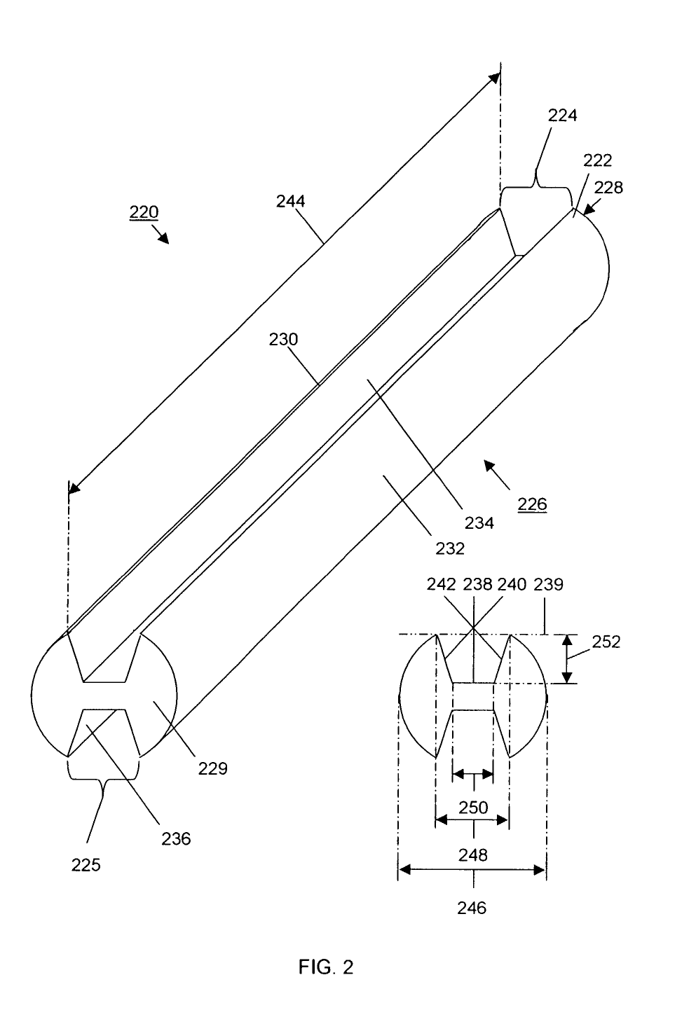

Referring to FIG. 2, geometric views of a substrate for a fiber optic device in one embodiment of the invention are provided. An isometric view and a cross-sectional view of the substrate 220 are shown. The substrate 220 is comprised of an elongate member 222 with two grooves 224, 225. The grooves 224, 225 are substantially parallel to a longitudinal axis of the elongate member 222. The elongate member 222 has a generally cylindrical shape. The elongate member 222 is defined by an elongate surface 226 and two ends 228, 229. The elongate surface 226 is further defined by the generally cylindrical shape of the elongate member 222 and the two grooves 224, 225

The elongate surface 226 is still further defined by four surface portions: 1) a first exterior surface 230 defined by the generally cylindrical shape of the elongate member 222, 2) a second exterior surface 232 defined by the generally cylindrical shape of the elongate member 222, 3) a first recessed surface 234 defined by the shape of the groove 224, and 4) a second recessed surface 236 defined by the shape of the groove 225. As shown, the two recessed surfaces 234, 236 are substantially the same dimension and disposed on opposing sides of the elongate member 222. Likewise, as shown, the two exterior surfaces 230, 232 are substantially the same dimension and disposed on opposing sides of the elongate member 222. Accordingly, as shown, the elongate surface 226 is generally symmetrical. Alternatively, the grooves 224, 225 of the substrate 220 can have different dimensions, different shapes, be disposed at different angles to each other, or any combination thereof, creating numerous additional embodiments of the invention.

The recessed surfaces 234, 236 are further described in reference to the cross-sectional view of the substrate 220. As shown, the recessed surfaces 234, 236 are generally defined by an inverted conical shape. However, the inverted conical shape is modified by flattening an end 238 of the conical shape so that the flattened end 238 is generally parallel to a line 239 intersecting the end of both legs 240, 242 of the conical shape. More specifically, the first recessed surface 234 is defined by three surface portions: 1) a first linear surface 240 is recessed from the first exterior surface 230 in accordance with the inverted conical shape, 2) a second linear surface 242 is recessed from the second exterior surface 232 in accordance with the inverted conical shape, and 3) a flattened end surface 238 is attached to both the first and second linear surfaces 240, 242 and parallel to a line 239 intersecting the point at which the first linear surface 240 is attached to the first exterior surface 230 and the point at which the second linear surface 242 is attached to the second exterior surface 232.

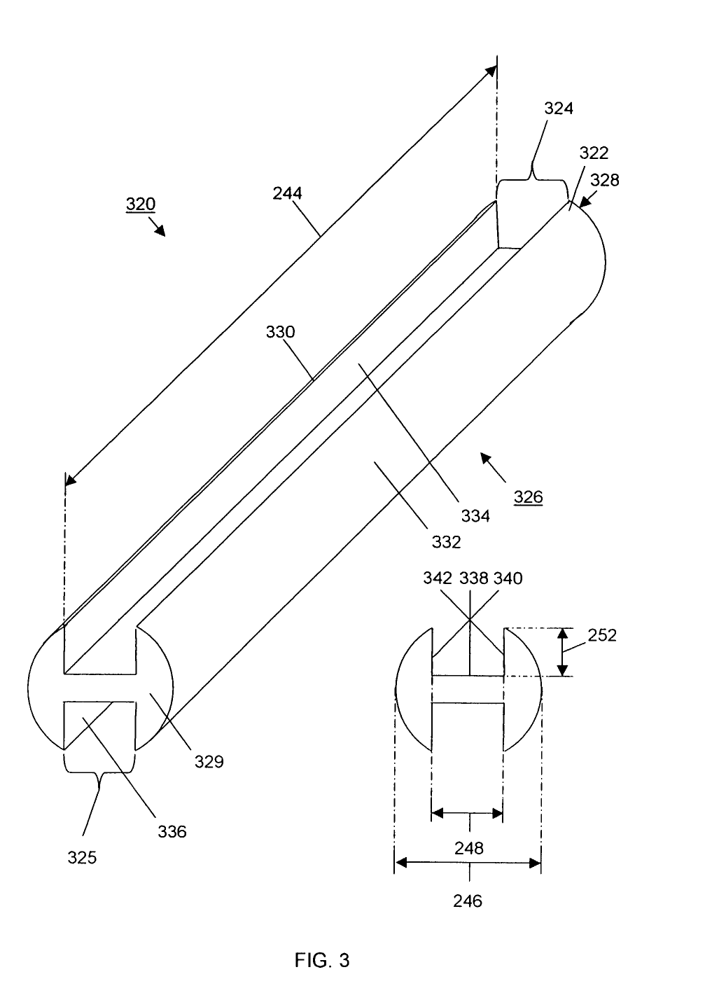

Referring to FIG. 3, geometric views of a substrate for a fiber optic device in another embodiment of the invention are provided. An isometric view and a cross-sectional view of the substrate 320 are shown. The substrate 320 is comprised of an elongate member 322 with two grooves 324, 325. The grooves 324, 325 are substantially parallel to a longitudinal axis of the elongate member 322. The elongate member 322 has a generally cylindrical shape. The elongate member 322 is defined by an elongate surface 326 and two ends 328, 329. The elongate surface 326 is further defined by the generally cylindrical shape of the elongate member 322 and the two grooves 324, 325.

The elongate surface 326 is still further defined by four surface portions: 1) a first exterior surface 330 defined by the generally cylindrical shape of the elongate member 322, 2) a second exterior surface 332 defined by the generally cylindrical shape of the elongate member 322, 3) a first recessed surface 334 defined by the shape of the groove 324, and 4) a second recessed surface 336 defined by the shape of the groove 325. As shown, the two recessed surfaces 334, 336 are substantially the same dimension and disposed on opposing sides of the elongate member 322. Likewise, as shown, the two exterior surfaces 330, 332 are substantially the same dimension and disposed on opposing sides of the elongate member 322. Accordingly, as shown, the elongate surface 326 is generally symmetrical. Alternatively, the grooves 324, 325 of the substrate 320 can have different dimensions, different shapes, be disposed at different angles to each other, or any combination thereof, creating numerous additional embodiments of the invention.

The recessed surfaces 334, 336 are further described in reference to the cross-sectional view of the substrate 320. As shown, the recessed surfaces 334, 336 are generally defined by an inverted half rectangular shape. More specifically, the first recessed surface 334 is defined by three surface portions: 1) a first linear surface 340 is recessed from the first exterior surface 330 in accordance with the inverted half rectangular shape, 2) a second linear surface 342 is recessed from the second exterior surface 332 and parallel to the first linear surface 340 in accordance with the inverted half rectangular shape, and 3) a third linear surface 338 is attached and perpendicular to both the first and second linear surfaces 340, 342 in accordance with the inverted half rectangular shape.

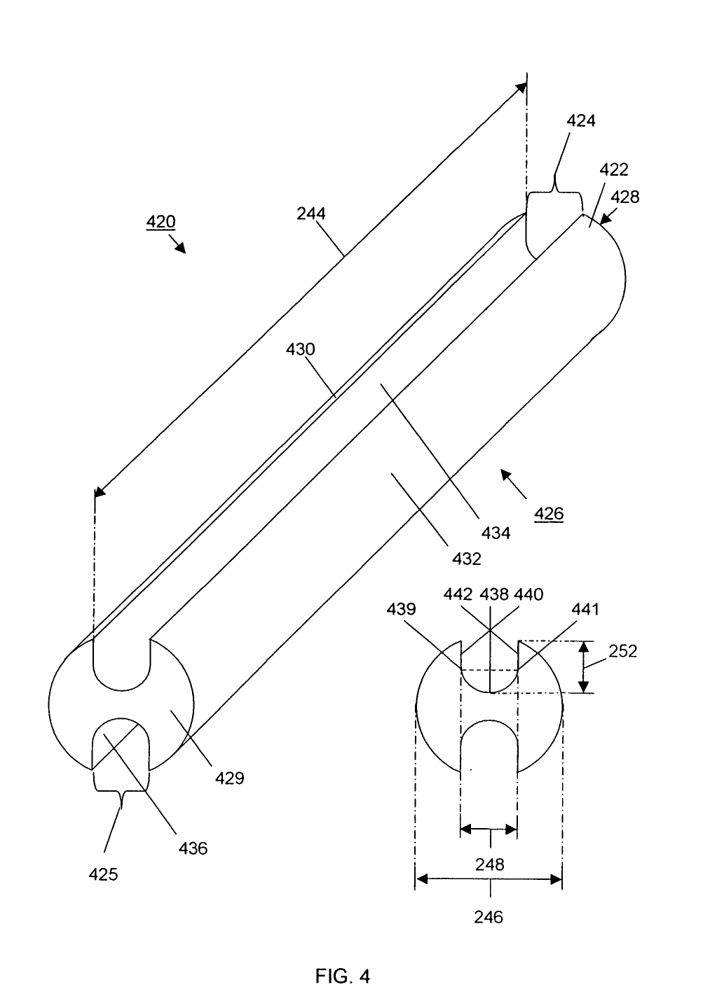

Referring to FIG. 4, geometric views of a substrate for a fiber optic device in still another embodiment of the invention are provided. An isometric view and a cross-sectional view of the substrate 420 are shown. The substrate 420 is comprised of an elongate member 422 with two grooves 424, 425. The grooves 424, 425 are substantially parallel to a longitudinal axis of the elongate member 422. The elongate member 422 has a generally cylindrical shape. The elongate member 422 is defined by an elongate surface 426 and two ends 428, 429. The elongate surface 426 is further defined by the generally cylindrical shape of the elongate member 422 and the two grooves 424, 425.

The elongate surface 426 is still further defined by four surface portions: 1) a first exterior surface 430 defined by the generally cylindrical shape of the elongate member 422, 2) a second exterior surface 432 defined by the generally cylindrical shape of the elongate member 422, 3) a first recessed surface 434 defined by the shape of the groove 424, and 4) a second recessed surface 436 defined by the shape of the groove 425. As shown, the two recessed surfaces 434, 436 are substantially the same dimension and disposed on opposing sides of the elongate member 422. Likewise, as shown, the two exterior surfaces 430, 432 are substantially the same dimension and disposed on opposing sides of the elongate member 422. Accordingly, as shown, the elongate surface 426 is generally symmetrical. Alternatively, the grooves 424, 425 of the substrate 420 can have different dimensions, different shapes, be disposed at different angles to each other, or any combination thereof, creating numerous additional embodiments of the invention.

The recessed surfaces 434, 436 are further described in reference to the cross-sectional view of the substrate 420. As shown, the recessed surfaces 434, 436 are generally defined by an inverted half circular shape. However, the inverted half circular shape is modified by extending the ends of the inverted half circular shape along lines tangential to the ends of the inverted half circular shape. More specifically, the first recessed surface 434 is defined by three surface portions: 1) a first arcuate surface 438 in accordance with the inverted half circular shape, 2) a second linear surface 440 is recessed from the first exterior surface 430 and attached to a first end 439 of the first arcuate surface 438 so that the second linear surface 440 has a tangential relationship to the first end 439 of the first arcuate surface 438, and 3) a third linear surface 442 is recessed from the second exterior surface 432 and attached to a second end 441 of the first arcuate surface 438 so that the third linear surface 442 has a tangential relationship to the second end 441 of the first arcuate surface 438.

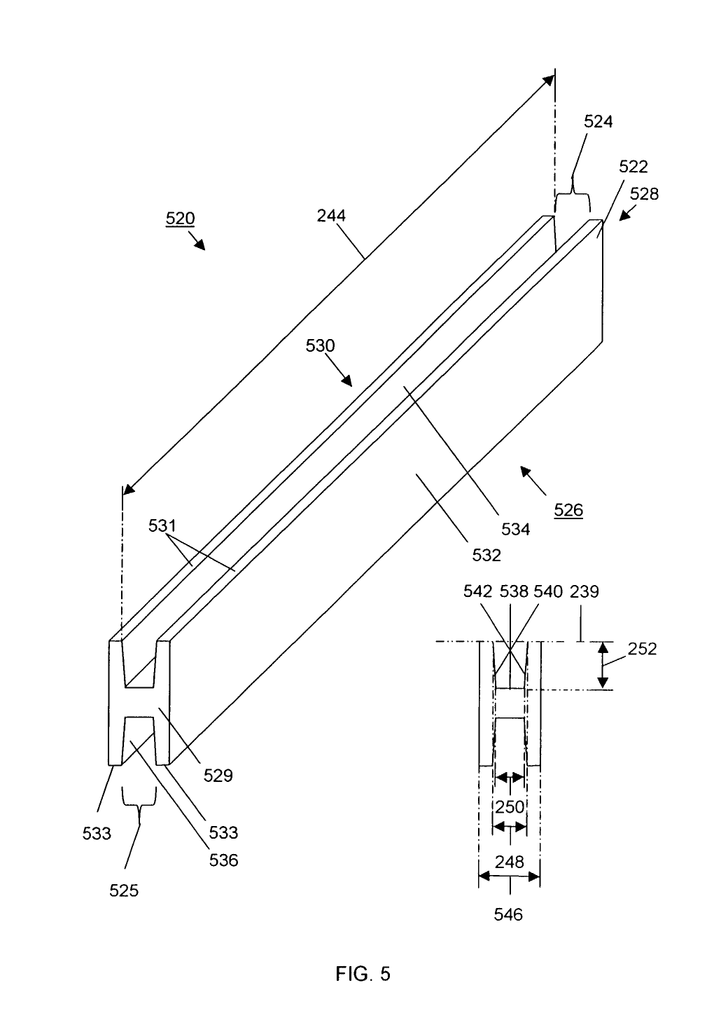

Referring to FIG. 5, geometric views of a substrate for a fiber optic device in yet another embodiment of the invention are provided. An isometric view and a cross-sectional view of the substrate 520 are shown. The substrate 520 is comprised of an elongate member 522 with two grooves 524, 525. The grooves 524, 525 are substantially parallel to a longitudinal axis of the elongate member 522. The elongate member 522 has a generally rectangular cross-sectional shape. The elongate member 522 is defined by an elongate surface 526 and two ends 528, 529. The elongate surface 526 is further defined by the generally rectangular shape of the elongate member 522 and the two grooves 524, 525.

The elongate surface 526 is still further defined by six surface portions: 1) a first exterior surface 530 defined by the generally rectangular shape of the elongate member 522, 2) a second exterior surface 532 defined by the generally rectangular shape of the elongate member 222, 3) a third exterior surface 531 defined by the generally rectangular shape of the elongate member 222, 4) a fourth exterior surface 533 defined by the generally rectangular shape of the elongate member 222, 5) a first recessed surface 534 defined by the shape of the groove 524, and 4) a second recessed surface 536 defined by the shape of the groove 525. As shown, the two recessed surfaces 534, 536 are substantially the same dimension and disposed on opposing sides of the elongate member 222. Likewise, as shown, each of the opposing exterior surfaces 530, 532 and 531, 533 are substantially the same dimension as the exterior surface disposed on the opposing side of the elongate member 522. Accordingly, as shown, the elongate surface 526 is generally symmetrical. Alternatively, the grooves 524, 525 of the substrate 520 can have different dimensions, different shapes, be disposed at different angles to each other, or any combination thereof, creating numerous additional embodiments of the invention.

The recessed surfaces 534, 536 are further described in reference to the cross-sectional view of the substrate 520. As shown, the recessed surfaces 534, 536 are generally defined by an inverted conical shape. However, the inverted conical shape is modified by flattening an end 538 of the conical shape so that the flattened end 538 is generally parallel to a line 239 intersecting the end of both legs 540, 542 of the conical shape. More specifically, the first recessed surface 534 is defined by three surface portions: 1) a first linear surface 540 is recessed from the first exterior surface 530 in accordance with the inverted conical shape, 2) a second linear surface 542 is recessed from the second exterior surface 532 in accordance with the inverted conical shape, and 3) a flattened end surface 538 is attached to both the first and second linear surfaces 540, 542 and parallel to a line 239 intersecting the point at which the first linear surface 540 is attached to the first exterior surface 530 and the point at which the second linear surface 542 is attached to the second exterior surface 532.

Referring to FIGS. 2 and 5, one of ordinary skill in the art will recognize the similarities of substrate 220 and substrate 520 due to the common shapes (e.g., inverted conical) of the grooves 224, 225 of FIG. 2 and the grooves 524, 525 of FIG. 5. Just as the different shapes of the substrate 220 of FIG. 2 (e.g., generally cylindrical) and the substrate 520 of FIG. 5 (e.g, generally rectangular) can incorporate the same shaped groove (e.g., inverted conical), so also can various other shapes of the substrate (e.g., substrates with oval, triangular, square, pentagonal, hexagonal, octagonal, etc. shaped cross-sections) incorporate inverted conical shaped grooves.

Additionally, referring to FIGS. 3-5, the inverted half rectangle shaped grooves of FIG. 3 and the inverted half circular shaped grooves of FIG. 4 can be incorporated in the rectangular shaped substrate of FIG. 5. Likewise, the inverted half rectangle shaped grooves of FIG. 3 and the inverted half circular shaped grooves of FIG. 4 can also be incorporated in various other shapes of substrates (e.g., substrates with oval, triangular, square, rectangular, pentagonal, hexagonal, octagonal, etc. shaped cross-sections).

Referring to FIGS. 2-5, the substrates 220, 320, 420, and 520 can be made from glass, silicon, sapphire, ceramic, or other suitable materials. Preferably, glass (e.g., Clear-Strate™ fused quartz by Quality Quartz of America, Inc.), generically known as vitreous silica, is used to make the substrate. The substrate can be formed by machining, extruding, or other suitable methods. The length 244 of the substrate 220, 320, 420, 520 can range from 5 mm to 100 mm with a typical tolerance of +/−0.25 mm. The outside diameter 246 of the substrate 220, 320, and 420 can range from 1 mm to 5 mm with a typical tolerance of +/−0.10 mm. The exterior width 546 of the substrate 520 can range from 1 mm to 3.5 mm with a typical tolerance of +/−0.10 mm. The upper width 248 of the groove may have a typical tolerance of +/−0.10 mm. The lower width 250 of the groove may have a typical tolerance of +/−0.10 mm. The depth 252 of the groove may have a typical tolerance of +/−0.10 mm. Alternate dimensions and tolerances, suitable for use in fiber optic devices, will be clear to those skilled in the art upon reading this disclosure. Such alternate dimensions and tolerances are considered within the scope of this disclosure and the attached claims.

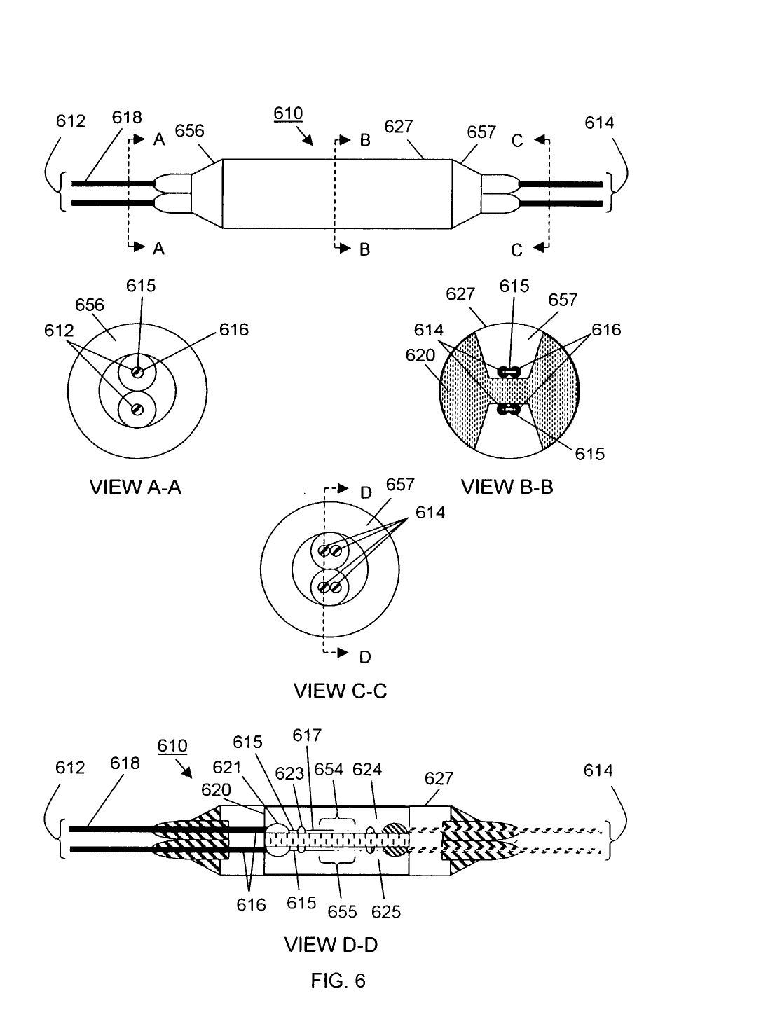

Referring to FIG. 6, geometric views and a cross-sectional view of a fiber optic device using the substrate in the embodiment shown in FIG. 2 are provided. The fiber optic device 610 is comprised of two fiber optic input cables 612, four fiber optic output cables 614, and a substrate 620. As shown, the substrate 620 is like the substrate 220 described above in reference to FIG. 2 and made from, for example, Clear-Strate™ fused quartz. However, the substrate 620 and its grooves can have a cross-section in various other shapes (e.g., substrate 320, 420, 520, and others, as described above). Each fiber optic cable 612, 614 is comprised of an optical fiber 615 clad in a fiber jacket 616 with a connection end 617 and a lead end 618. A length of the fiber jacket 616 is removed from a predetermined portion of the connection end 617. The substrate 620 includes two optically isolated grooves 624, 625, each groove (e.g., 624) receiving one fiber optic input cable 612 and two fiber optic output cables 614. The fiber jacket 616 of each fiber optic cable 612, 614 is disposed in an end portion of the groove 624, 625 and may be secured in position with an epoxy 621 or equivalent adhesive. The epoxy 621 or equivalent adhesive provides a form of strain relief to the fiber optic cable 612, 614 and a form of protection to the interior connections of the optical fibers 615. The optical fiber 615 of each fiber optic cable 612, 614 is disposed in a connection region 654, 655 of the groove 624, 625 and may be secured in position with a suitable adhesive 623 or an equivalent material compatible with the materials of the optical fiber 615 and the substrate 620. The adhesive 623 or equivalent material provides support for the optical fibers 615.

As shown, the optical fibers 615 from one fiber optic input cable 612 and two fiber optic output cables 614 in a first connection region 654 are connected to each other forming a first coupling. The optical fibers 615 from the one fiber optic input cable 612 and the two fiber optic output cables 614 in a second connection region 655 are connected to each other forming a second coupling. The substrate 620 and the connection ends 618 of the fiber optic cables 612, 614 are packaged in an enclosure 627. The enclosure 627 may be adapted for use with strain relief boots 656, 657 on each end of the enclosure 627. Openings in the strain relief boots 656, 657 receive the fiber optic cables 612, 614 and provide strain relief to protect the interior connections of the optical fibers 615.

The fiber optic device 610 of FIG. 6 may be assembled using four fiber optic cables. A length of the fiberjacket 616 is removed from a middle portion of each cable to expose the optical fiber 615. The first optically isolated groove 624 receives two of the fiber optic cables such that the exposed optical fibers 615 are disposed in the first connection region 654. The two exposed optical fibers 615 are connected together in the first connection region 654 forming a first coupling with four fiber optic cables, each cable having a connection end 617 connected to form the first coupling and a lead end 618 extending outward from the first coupling. One of the fiber optic cables is selected and severed from the first coupling, leaving the lead ends 618 of one fiber optic input cable 612 and two fiber optic output cables 614 extending from opposing ends of the first optically isolated groove 624. The second optically isolated groove 625 receives the other two fiber optic cables such that the exposed optical fibers 615 are disposed in the second connection region 655. These two exposed optical fibers 615 are connected together in the second connection region 655 forming a second coupling with four fiber optic cables, each cable having a connection end 617 connected to for the second coupling and a lead end 618 extending outward from the second coupling. One of the fiber optic cables is selected and severed from the second coupling, leaving the lead ends 618 of one fiber optic input cable 612 and two fiber optic output cables 614 extending from opposing ends of the second optically isolated groove 625. The substrate 620 and the couplings are packaged in the enclosure 627.

As described, the fiber optic device 610 of FIG. 6 is a fiber optic coupler assembly with two optically isolated couplings. As shown, both couplings are commonly known as 1×2 dividers. Alternatively, simply by reversing the input and output ports, in other words defining item 612 as fiber optic output cables and item 614 as fiber optic input cables, both couplings are commonly known as 2×1 combiners. In alternate configurations, the fiber optic device can have multiple input ports (e.g., 1 to 64) and multiple output ports (e.g., 1 to 64) for each optically isolated coupling

In still further alternative configurations, the fiber optic device 610 can include one or more additional components (e.g., waveguides and/or semiconductor devices) and each of the optical fibers 615 can be connected to a predetermined point on the additional component(s). These alternate configurations are examples of using the substrate 620 made from, for example, Clear-Strate™ fused quartz in optical switches, wavelength-division multiplexers, and optical repeaters. The additional component(s) are disposed in the connection region 654, 655 of at least one of the optically isolated grooves 624, 625 of the substrate 620. Assuming at least one additional component is disposed in each of the grooves 624, 625, the fiber optic device 610 of FIG. 6 may be assembled using four or more fiber optic cables. A length of the fiber jacket 616 is removed from a connection end 617 of each cable to expose the optical fiber 615. The first optically isolated groove 624 receives at least two fiber optic cables such that the connection ends 617 are disposed in the first connection region 654. The connection ends 617 are connected to predetermined points on the additional component(s) with the lead ends 618 extending outward from the substrate 620. The second optically isolated groove 625 also receives at least two fiber optic cables such that the connection ends 617 are disposed in the second connection region 655. The connection ends 617 are connected to predetermined points on the additional component(s) with the lead ends 618 extending outward from the substrate 620. The substrate 620 and additional component(s) are packaged in the enclosure 627.

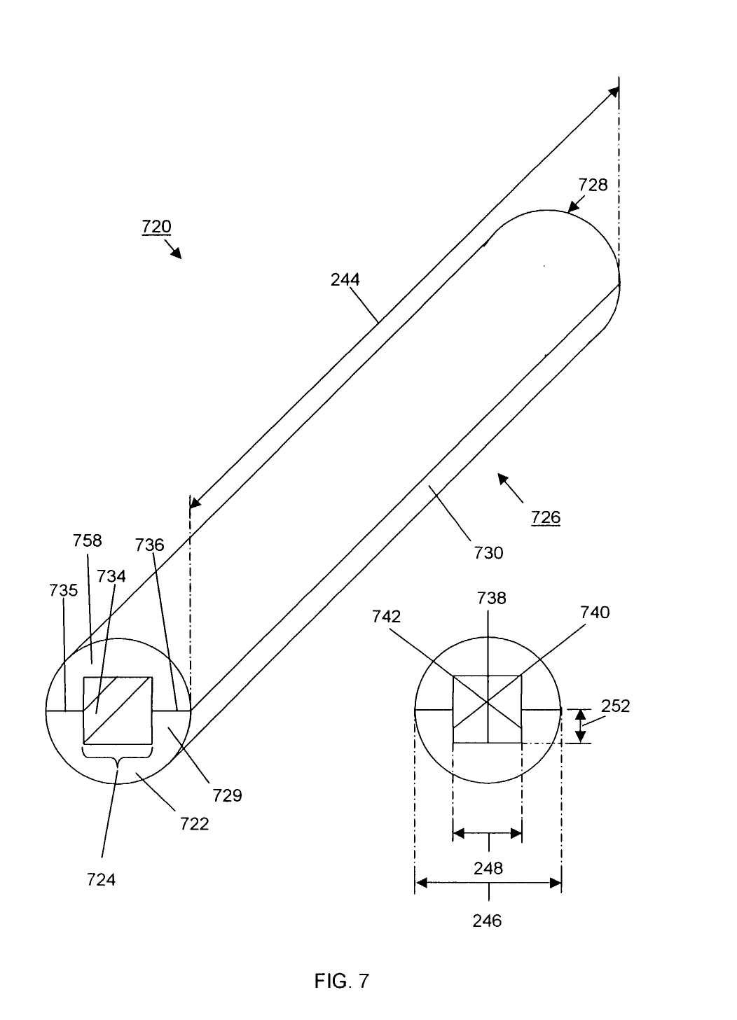

Referring to FIG. 7, geometric views of a substrate for a fiber optic device in one embodiment of the invention is provided. An isometric view and a cross-sectional view of the substrate 720 is shown. The substrate 720 is comprised of two elongate members 722, 758. Each elongate member (e.g., 722) has a mating surface facing the associated elongate member. There is a groove 724 in the mating surface of the elongate member 722. The groove 724 is substantially parallel to a longitudinal axis of the elongate member 722. For alignment, the mating surface may also include nubs and corresponding slots in the associated mating surface, slots and corresponding nubs in the associated mating surface, ridges and corresponding grooves in the associated mating surface, grooves and corresponding ridges in the associated mating surface, other types of suitable alignment features, or any combination thereof

The elongate member 722 has a generally half cylindrical shape. The elongate member 722 is defined by an elongate surface 726 and two ends 728, 729 The elongate surface 726 is further defined by the generally half cylindrical shape of the elongate member 722 and the groove 724. The elongate surface 726 is still further defined by two surface portions: 1) an exterior surface 730 defined by the generally half cylindrical shape of the elongate member 722 and 2) a mating surface. The mating surface is defined by a first interior surface 735 and a second interior surface 737 based on the generally half cylindrical shape of the elongate member 722 and a recessed surface 734 defined by the shape of the groove 724.

The recessed surface 734 is further described in reference to the cross-sectional view of the substrate 720. As shown, the recessed surface 734 is generally defined by an inverted half rectangular shape. More specifically, the recessed surface 734 is defined by three surface portions: 1) a first linear surface 740 is recessed from the first interior surface 735 in accordance with the inverted half rectangular shape, 2) a second linear surface 742 is recessed from the second interior surface 737 and parallel to the first linear surface 740 in accordance with the inverted half rectangular shape, and 3) a third linear surface 738 is attached and perpendicular to both the first and second linear surfaces 740, 742 in accordance with the inverted half rectangular shape. Alternatively, the inverted conical shaped grooves of FIGS. 2 and 5 or the inverted half circular grooves of FIG. 4 can be incorporated in the elongated members 722, 758 of the substrate 720 shown in FIG. 7.

As shown, the recessed surfaces 734 of the associated elongate members 722, 758 are substantially the same dimension. Likewise, as shown, the exterior surfaces 730 of the associated elongate members 722, 758 are substantially the same dimension. Accordingly, as shown, the associated elongate members 722, 758 are generally symmetrical. Alternatively, the grooves 724 of the elongate members 722, 758 can have different dimensions, different shapes, or any combination thereof, creating numerous additional embodiments of the invention. Additionally, the overall half cylindrical shape of an elongate member can be varied. For example, the cross-section of the overall shape can be half oval, triangular, square, rectangular, half pentagonal, half hexagonal, half octagonal, etc. Still further alternatives include substrates made from two elongate members with different cross-sectional shapes and/or different groove shapes.

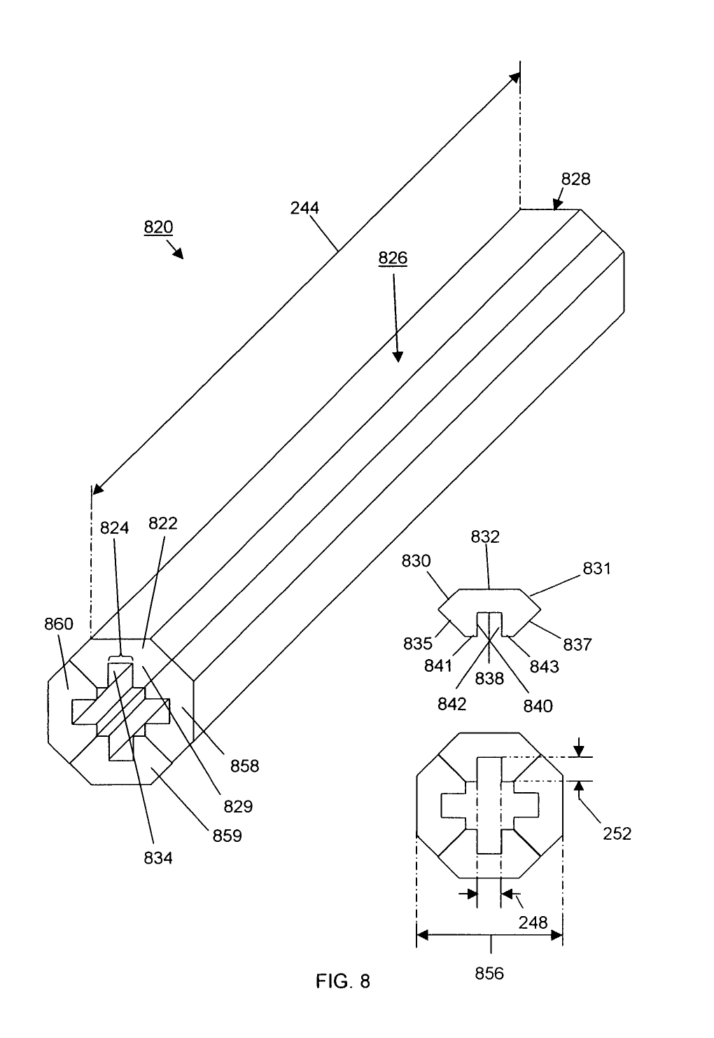

Referring to FIG. 8, geometric views of a substrate for a fiber optic device in another embodiment of the invention is provided. An isometric view and a cross-sectional view of the substrate 820 is shown. The substrate 820 is comprised of four elongate members 822, 858, 859, 860. Each elongate member (e.g., 822) has two mating surfaces facing adjacent elongate members (e.g., 858, 860) and an interior surface facing an opposite elongate member (e.g., 859). There is a groove 824 in the interior surface of the elongate member 822. The groove 824 is substantially parallel to a longitudinal axis of the elongate member 822. For alignment, the mating surfaces may also include nubs and corresponding slots in the mating surface of the adjacent elongate member, slots and corresponding nubs in the mating surface of the adjacent elongate member, ridges and corresponding grooves in the mating surface of the adjacent elongate member, grooves and corresponding ridges in the mating surface of the adjacent elongate member, other types of suitable alignment features, or any combination thereof

The elongate member 822 has a generally quarter octagonal cross-sectional shape with the octagonal shape quartered at approximately the mid-point of alternating octagonal sections. The elongate member 822 is defined by an elongate surface 826 and two ends 828, 829. The elongate surface 826 is further defined by the generally quarter octagonal shape of the elongate member 822 and the groove 824. The elongate surface 826 is still further defined by two surface portions: 1) an exterior surface and 2) an interior surface. The exterior surface is defined by the generally quarter octagonal shape of the elongate member 822 and includes a first exterior portion 830 relating to half of an octagonal section, a second exterior portion 832 relating to an octagonal section, and a third exterior portion 831 relating to half of an octagonal section. The interior surface is defined by a first mating surface 835 facing a first adjacent elongate member, a second mating surface 837 facing a second adjacent elongate member, first and second interior surfaces 841, 843 generally parallel to the second exterior surface 832 and facing an opposite elongate member, and 4) a recessed surface 834 defined by the shape of the groove 824.

The recessed surface 834 is further described in reference to the cross-sectional view of the substrate 820. As shown, the recessed surface 834 is generally defined by an inverted half rectangular shape. More specifically, the recessed surface 834 is defined by three surface portions: 1) a first linear surface 840 is recessed from the first interior surface 835 in accordance with the inverted half rectangular shape, 2) a second linear surface 842 is recessed from the second interior surface 837 and parallel to the first linear surface 840 in accordance with the inverted half rectangular shape, and 3) a third linear surface 838 is attached and perpendicular to both the first and second linear surfaces 840, 842 in accordance with the inverted half rectangular shape. Alternatively, the inverted conical shaped grooves of FIGS. 2 and 5 or the inverted half circular grooves of FIG. 4 can be incorporated in the elongated members 822, 858, 859, 860 of the substrate 820 shown in FIG. 8.

As shown, the recessed surfaces 834 of the associated elongate members 822, 858, 859, 860 are substantially the same dimension. Likewise, as shown, the exterior surfaces 830 and interior surfaces 835, 837, 841, 843 of the associated elongate members 822, 858, 859, 860 are substantially the same dimension. Accordingly, as shown, the associated elongate members 822, 858, 859, 860 are generally symmetrical. Alternatively, the grooves 824 of the elongate members 822, 858, 859, 860 can have different dimensions, different shapes, or any combination thereof, creating numerous additional embodiments of the invention Additionally, the method of quartering the octagonal cross-section can be varied so that the exterior surface includes two full octagonal sections instead of quartering the sections at approximately the mid-point of alternating sections. Of course, the method of quartering the octagonal cross-section can also be varied by quartering the octagonal sections at any point in alternating sections as long as each quadrant is quartered in relatively the same manner. This alternative would produce non-symmetrical elongate members.

Additionally, the overall shape of an elongate member can be varied. For example, the cross-section of the overall shape can be quarter circle, quarter square, quarter rectangular, quarter oval, etc. Still further alternatives include substrates made from two elongate members with different cross-sectional shapes and/or different groove shapes.

Referring to FIGS. 7 and 8, the substrates 720 and 820 can be made from glass, silicon, sapphire, ceramic, or other suitable materials. Preferably, glass (e.g, Clear-Strate™ fused quartz by Quality Quartz of America, Inc.), generically known as vitreous silica, is used to make the substrate. The substrate can be formed by machining, extruding, or other suitable methods The length 244 of the substrate 720, 820 can range from 5 mm to 100 mm with a typical tolerance of +/−0.25 mm. The outside diameter 246 of the substrate 720 can range from 1 mm to 5 mm with a typical tolerance of +/−0. 10 mm. The exterior width 846 of the substrate 820 can range from 1.5 mm to 6 mm with a typical tolerance of +/−0.10 mm. The width 248 of the groove may have a typical tolerance of +/−0.10 mm. The depth 252 of the groove may have a typical tolerance of +/−0.10 mm. Alternate dimensions and tolerances, suitable for use in fiber optic devices, will be clear to those skilled in the art upon reading this disclosure. Such alternate dimensions and tolerances are considered within the scope of this disclosure and the attached claims.

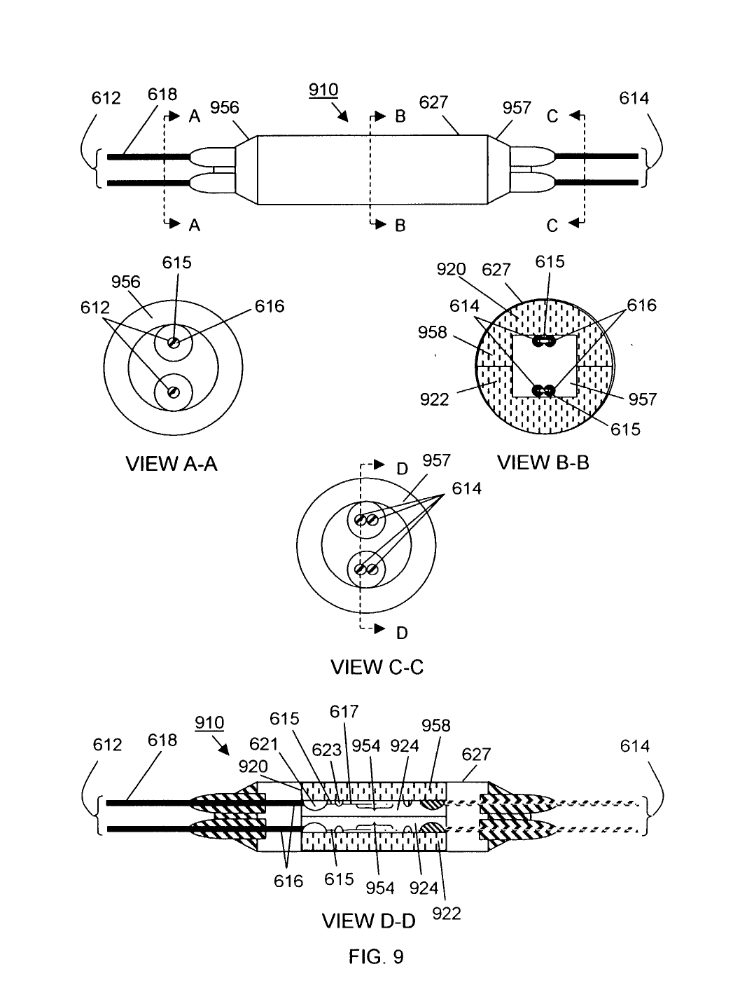

Referring to FIG. 9, geometric views and a cross-sectional view of a fiber optic device using the substrate in the embodiment shown in FIG. 7 are provided. Similar to the fiber optic device 610 of FIG. 6, the fiber optic device 910 is comprised of two fiber optic input cables 612, four fiber optic output cables 614, and a substrate 920. As shown, the substrate 920 is like the substrate 720 described above in reference to FIG. 7 and made from, for example, Clear-Strate™ fused quartz. However, the substrate 920 can include more than two elongate members 922, 958 (e.g., three elongate members, substrate 820 with four elongate members, etc.), the cross-sections of the substrate 920 can be in various other shapes (e.g., oval, triangular, square, rectangular, pentagonal, hexagonal, octagonal ( see FIG. 8), etc.), and the grooves can have a cross-section in various other shapes (e g., substrate 220, 420, 520, and others, as described above). The fiber optic cables 612, 614 are as described above in reference to FIG. 6. The substrate 920 includes two elongate members 922, 958. Each elongate member (e.g., 922) includes an optically isolated groove 924. Like the fiber optic device 610 of FIG. 6, each groove 924 receives one fiber optic input cable 612 and two fiber optic output cables 614. The fiber jacket 616 of each fiber optic cable 612, 614 is disposed in an end portion of the groove 924 and may be secured in position with an epoxy 621 or equivalent adhesive. Like in FIG. 6, the epoxy 621 or equivalent adhesive provides a form of strain relief to the fiber optic cable 612, 614 and a form of protection to the interior connections of the optical fibers 615. The optical fiber 615 of each fiber optic cable 612, 614 is disposed in a connection region 954 of the groove 924 and may be secured in position with a suitable adhesive 923 or an equivalent material compatible with the materials of the optical fiber 615 and the substrate 920. Like in FIG. 6, the adhesive 623 or equivalent material provides support for the optical fibers 615.

As shown, the optical fibers 615 from one fiber optic input cable 612 and two fiber optic output cables 614 in the connection region 954 of the first elongate member 922 are connected to each other forming a first coupling. The optical fibers 615 from the one fiber optic input cable 612 and the two fiber optic output cables 614 in the connection region 954 of the second elongate member 958 are connected to each other forming a second coupling. The substrate 920 and the connection ends 618 of the fiber optic cables 612, 614 are packaged in an enclosure 927. The enclosure 927 may be adapted for use with strain relief boots 956, 957 on each end of the enclosure 927 Openings in the strain relief boots 956, 957 receive the fiber optic cables 612, 614 and provide strain relief to protect the interior connections of the optical fibers 615.

Like the fiber optic device 610 of FIG. 6, the fiber optic device 910 of FIG. 9 may be assembled using four fiber optic cables. A length of the fiber jacket 616 is removed from a middle portion of each cable to expose the optical fiber 615. The optically isolated groove 624 in the first elongate member 922 receives two of the fiber optic cables such that the exposed optical fibers 615 are disposed in the connection region 954 The two exposed optical fibers 615 are connected together in the connection region 954 forming a first coupling with four fiber optic cables, each cable having a connection end 617 connected together to form the first coupling and a lead end 618 extending outward from the first coupling. One of the fiber optic cables is selected and severed from the first coupling leaving the lead ends 618 of one fiber optic input cable 612 and two fiber optic output cables 614 extending from opposing ends of the optically isolated groove 924 in the first elongate member 922. The optically isolated groove 924 in the second elongate member 958 receives the other two fiber optic cables such that the exposed optical fibers 615 are disposed in the connection region 954. These two exposed optical fibers 615 are connected together in the connection region 954 forming a second coupling with four fiber optic cables, each cable having a connection end 617 connected together to form the second coupling and a lead end 618 extending outward from the second coupling. One of the fiber optic cables is selected and severed from the second coupling leaving the lead ends 618 of one fiber optic input cable 612 and two fiber optic output cables 614 extending from opposing ends of the optically isolated groove 624 of the second elongate member 958. The substrate 920 and the couplings are packaged in the enclosure 927.

As described, the fiber optic device 910 of FIG. 9 is a fiber optic coupler assembly with two optically isolated couplings. As shown, both couplings are commonly known as 1×2 dividers. Alternatively, simply by reversing the input and output ports, in other words defining item 612 as fiber optic output cables and item 614 as fiber optic input cables, both couplings are commonly known as 2×1 combiners. In alternate configurations, the fiber optic device can have multiple input ports (e.g., 1 to 64) and multiple output ports (e.g., 1 to 64) for each optically isolated coupling.

In still further alternative configurations, the fiber optic device 910 can include one or more additional components (e.g., waveguides and/or semiconductor devices) and each of the optical fibers 615 can be connected to a predetermined point on the additional component(s). These alternate configurations are examples of using the substrate 920 made from, for example, Clear-Strate™ fused quartz in optical switches, wavelength-division multiplexers, and optical repeaters. The additional component(s) are disposed in the connection regions 954 of at least one of the optically isolated grooves 924 of the substrate 920. Assuming at least one additional component is disposed in each of the grooves 924, the fiber optic device 910 of FIG. 9 may be assembled using four or more fiber optic cables. A length of the fiber jacket 616 is removed from a connection end 617 of each cable to expose the optical fiber 615. The optically isolated groove 924 in the first elongate member 922 receives at least two fiber optic cables such that the connection ends 617 are disposed in the connection region 954. The connection ends 617 are connected to predetermined points on the additional component(s) with the lead ends 618 extending outward from the substrate 920. The optically isolated groove 924 in the second elongate member 958 also receives at least two fiber optic cables such that the connection ends 617 are disposed in the connection region 954. The connection ends 617 are connected to predetermined points on the additional component(s) with the lead ends 618 extending outward from the substrate 920. The substrate 920 and additional component(s) are packaged in the enclosure 927.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

Having thus described the several embodiments, the invention claimed is:

1. A fiber optic coupler assembly, comprising:
a substrate with at least two optically isolated grooves, each groove for receiving at least three fiber optic cables, wherein each groove includes a connection region for receiving an optical fiber associated with each fiber optic cable associated with the groove;
a plurality of fiber optic cables, including at least three cables associated with each groove, each cable having a connection end and a lead end, each cable having a fiber jacket removed from the connection end of the cable to expose an optical fiber within the cable, wherein the optical fibers at the connection ends of the cables associated with each groove are disposed in the connection region of the associated groove, wherein the connection ends of the optical fibers of the cables in the associated groove are connected together to form a coupling, a coupling being formed in each groove; and
an enclosure for packaging the substrate with multiple fiber optic couplings with the lead ends of the fiber optic cables extending through openings of the enclosure.

2. The fiber optic coupler assembly as set forth in claim 1, the substrate further comprising:
an elongate member, wherein each groove is disposed on an exterior surface of the elongate member, wherein the grooves are substantially parallel to a longitudinal axis of the elongate member.

3. The fiber optic coupler assembly as set forth in claim 2, wherein a cross-section of the exterior surface of the elongate member is selected from the group consisting of a generally circular cross-section, a generally rectangular cross-section, a generally oval cross-section, a generally triangular cross-section, a generally pentagonal cross-section, a generally hexagonal cross-section, and a generally octagonal cross-section.

4. The fiber optic coupler assembly as set forth in claim 2, wherein the elongate member includes a first optically isolated groove and a second optically isolated groove, wherein the first and second grooves are disposed on opposing sides of the exterior surface of the elongate member, each groove having a first end and a second end, the first end of each groove corresponding to a first end of the substrate and the second end of each groove corresponding to a second end of the substrate.

5. The fiber optic coupler assembly as set forth in claim 4, wherein the plurality of fiber optic cables includes at least six cables, wherein at least one cable is disposed in the first end of the first groove, at least two cables are disposed in the second end of the first groove, at least one cable is disposed in the first end of the second groove, and at least two cables are disposed in the second end of the second groove.

6. The fiber optic coupler assembly as set forth in claim 5, further comprising:
a first strain relief member for receiving the lead ends of cables disposed in the first end of each groove;
a second strain relief member for receiving the lead ends of fiber optic cables disposed in the second end of each groove; and
wherein the enclosure receives the first strain relief member at a first end of the enclosure and the second strain relief member at a second end of the enclosure.

7. The substrate as set forth in claim 2, wherein the surface of the elongate member in a first groove is a recessed surface in relation to the exterior surface, wherein a cross-section of the recessed surface of the elongate member at the first groove is selected from the group consisting of an inverted generally conical cross-section, an inverted generally half rectangular cross-section, and an inverted generally half circular cross-section.

8. The fiber optic coupler assembly as set forth in claim 7, wherein the cross-section of the recessed surface of the elongate member at the first groove is the inverted generally conical cross-section, wherein the inverted generally conical cross-section is modified by flattening a point end of the inverted generally conical cross-section so that the point end is generally parallel in relation to an open end of the inverted generally conical cross-section.

9. The fiber optic coupler assembly as set forth in claim 7, wherein the cross-section of the recessed surface of the elongate member at the first groove is the inverted generally half rectangular cross-section, wherein the inverted generally half rectangular cross-section includes three portions, including a first generally linear portion, a second generally linear portion attached to the first portion and generally perpendicular thereto, and a third generally linear portion attached to the second portion, generally perpendicular thereto, and generally parallel to the first portion.

10. The fiber optic coupler assembly as set forth in claim 7, wherein the cross-section of the recessed surface of the elongate member at the first groove is the inverted generally half circular cross-section, wherein the inverted generally half circular cross-section is modified by extending the ends of an inverted generally half circular portion of the cross-section along lines generally tangential to the ends of the inverted generally half circular portion, wherein the modified cross-section includes three portions, including a first generally linear portion, a second inverted generally half circular portion attached to the first portion, and a third generally linear portion attached to the second portion and generally parallel to the first portion.

11. The fiber optic coupler assembly as set forth in claim 7, wherein the surface of the elongate member in a second groove is a second recessed surface in relation to the exterior surface, wherein a cross-section of the second recessed surface of the elongate member at the second groove is selected from the group consisting of an inverted generally conical cross-section, an inverted generally half rectangular cross-section, and an inverted generally half circular cross-section.

12. The fiber optic coupler assembly as set forth in claim 1, the substrate further comprising:
a first elongate member with a first exterior surface and a first mating surface, wherein a first optically isolated groove is disposed along the first mating surface, wherein the first groove is substantially parallel to a longitudinal axis of the first elongate member, wherein the first groove is for receiving a first fiber optic coupling; and
a second elongate member with a second exterior surface and a second mating surface, wherein the second mating surface is adapted to mate with the first mating surface, wherein a second optically isolated groove is disposed along the second mating surface, wherein the second groove is substantially parallel to a longitudinal axis of the second elongate member, wherein the second groove is for receiving a second fiber optic coupling.

13. The substrate as set forth in claim 12, wherein a cross-section of the first exterior surface is selected from the group consisting of a generally half circular cross-section, a generally half oval cross-section, a generally triangular cross-section, a generally rectangular cross-section, a generally half pentagonal cross-section, a generally half hexagonal cross-section, and a generally half octagonal cross-section.

14. The substrate as set forth in claim 13, wherein a cross-section of the second exterior surface is selected from the group consisting of a generally half circular cross-section, a generally half oval cross-section, a generally triangular cross-section, a generally rectangular cross-section, a generally half pentagonal cross-section, a generally half hexagonal cross-section, and a generally half octagonal cross-section.

15. The substrate as set forth in claim 12, wherein the first optically isolated groove is defined by a first recessed surface, the first recessed surface forming a part of the first mating surface, wherein a cross-section of the first recessed surface is selected from the group consisting of an inverted generally half rectangular cross-section, an inverted generally conical cross-section, and an inverted generally half circular cross-section.

16. The substrate as set forth in claim 15, wherein the second optically isolated groove is defined by a second recessed surface, the second recessed surface forming a part of the second mating surface, wherein a cross-section of the second recessed surface is selected from the group consisting of an inverted generally half rectangular cross-section, an inverted generally conical cross-section, and an inverted generally half circular cross-section.

17. The fiber optic coupler assembly as set forth in claim 1, the substrate further comprising:
a first elongate member with a first exterior surface and a first interior surface, wherein the first interior surface is defined by a first mating surface, a first interior portion, and a second mating surface, wherein a first optically isolated groove is disposed along the first interior portion, wherein the first groove is substantially parallel to a longitudinal axis of the first elongate member, wherein the first groove is for receiving a first fiber optic coupling;
a second elongate member with a second exterior surface and a second interior surface, wherein the second interior surface is defined by a third mating surface, a second interior portion, and a fourth mating surface, wherein the third mating surface is adapted to mate with the second mating surface of the first elongate member, wherein a second optically isolated groove is disposed along the second interior portion, wherein the second groove is substantially parallel to a longitudinal axis of the second elongate member, wherein the second groove is for receiving a second fiber optic coupling;
a third elongate member with a third exterior surface and a third interior surface, wherein the third interior surface is defined by a fifth mating surface, a third interior portion, and a sixth mating surface, wherein the fifth mating surface is adapted to mate with the fourth mating surface of the second elongate member, wherein a third optically isolated groove is disposed along the third interior portion, wherein the third groove is substantially parallel to a longitudinal axis of the third elongate member, wherein the third groove is for receiving a third fiber optic coupling; and
a fourth elongate member with a fourth exterior surface and a fourth interior surface, wherein the fourth interior surface is defined by a seventh mating surface, a fourth interior portion, and an eighth mating surface, wherein the seventh mating surface is adapted to mate with the sixth mating surface of the third elongate member, wherein the eighth mating surface is adapted to mate with the first mating surface of the first elongate member, wherein a fourth optically isolated groove is disposed along the fourth interior portion, wherein the fourth groove is substantially parallel to a longitudinal axis of the fourth elongate member, wherein the fourth groove is for receiving a fourth fiber optic coupling.

18. The substrate as set forth in claim 17, wherein a cross-section of the first exterior surface is selected from the group consisting of a generally quarter octagonal cross-section, a generally quarter circular cross-section, a generally quarter oval cross-section, a generally quarter square cross-section, and a generally quarter rectangular cross-section.

19. The substrate as set forth in claim 1 8, wherein a cross-section of the second exterior surface is selected from the group consisting of a generally quarter octagonal cross-section, a generally quarter circular cross-section, a generally quarter oval cross-section, a generally quarter square cross-section, and a generally quarter rectangular cross-section.

20. The substrate as set forth in claim 19, wherein a cross-section of the third exterior surface is selected from the group consisting of a generally quarter octagonal cross-section, a generally quarter circular cross-section, a generally quarter oval cross-section, a generally quarter square cross-section, and a generally quarter rectangular cross-section.

21. The substrate as set forth in claim 20, wherein a cross-section of the fourth exterior surface is selected from the group consisting of a generally quarter octagonal cross-section, a generally quarter circular cross-section, a generally quarter oval cross-section, a generally quarter square cross-section, and a generally quarter rectangular cross-section.

22. The substrate as set forth in claim 17, wherein the first optically isolated groove is defined by a first recessed surface, the first recessed surface forming a part of the first interior portion of the first interior surface, wherein a cross-section of the first recessed surface is selected from the group consisting of an inverted generally half rectangular cross-section, an inverted generally conical cross-section, and an inverted generally half circular cross-section.

23. The substrate as set forth in claim 22, wherein the second optically isolated groove is defined by a second recessed surface, the second recessed surface forming a part of the second interior portion of the second interior surface, wherein a cross-section of the second recessed surface is selected from the group consisting of an inverted generally half rectangular cross-section, an inverted generally conical cross-section, and an inverted generally half circular cross-section.

24. The substrate as set forth in claim 23, wherein the third optically isolated groove is defined by a third recessed surface, the third recessed surface forming a part of the third interior portion of the third interior surface, wherein a cross-section of the third recessed surface is selected from the group consisting of an inverted generally half rectangular cross-section, an inverted generally conical cross-section, and an inverted generally half circular cross-section.

25. The substrate as set forth in claim 24, wherein the fourth optically isolated groove is defined by a fourth recessed surface, the fourth recessed surface forming a part of the fourth interior portion of the fourth interior surface, wherein a cross-section of the fourth recessed surface is selected from the group consisting of an inverted generally half rectangular cross-section, an inverted generally conical cross-section, and an inverted generally half circular cross-section.

26. A fiber optic device, comprising:
a substrate with at least two optically isolated grooves, each groove for receiving at least two fiber optic cables, wherein each groove includes a connection region for receiving an optical fiber associated with each fiber optic cable associated with the groove;
at least one electronic component disposed in each groove of the substrate;
a plurality of fiber optic cables, including at least two cables associated with each groove, each cable having a connection end and a lead end, each cable having a fiber jacket removed from the connection end of the cable to expose an optical fiber within the cable, wherein the optical fibers at the connection ends of the cables associated with each groove are disposed in the connection region of the associated groove, wherein the connection ends of the optical fibers of the cables in the associated groove are connected to predetermined points on the electronic component(s) disposed in the associated groove; and
an enclosure for packaging the substrate with electronic components with the lead ends of the fiber optic cables extending through openings of the enclosure.

27. A method for assembling a fiber optic coupler assembly, comprising the steps of:
a) receiving at least two fiber optic cables in a first optically isolated groove of a substrate, each cable having a fiber jacket of the cable removed from a middle portion of the cable to expose an optical fiber within the cable;
b) connecting the exposed optical fibers of each cable together in a connecting region of the first groove to form a first fiber optic coupling with at least four coupled fiber optic cables extending therefrom, each coupled fiber optic cable having a connection end joined in the first coupling and a lead end extending outward from the first groove;
c) selecting at least one of the coupled fiber optic cables from the first coupling and severing the selected coupled fiber optic cable(s) from the first coupling;
d) receiving at least two fiber optic cables in a second optically isolated groove of the substrate, each cable having a fiber jacket of the cable removed from a middle portion of the cable to expose an optical fiber within the cable;
e) connecting the exposed optical fibers of each cable together in a connecting region of the second groove to form a second fiber optic coupling with at least four coupled fiber optic cables extending therefrom, each coupled fiber optic cable having a connection end joined in the second coupling and a lead end extending outward from the second groove; and
f) selecting at least one of the coupled fiber optic cables from the second coupling and severing the selected coupled fiber optic cable(s) from the second coupling.

28. The method as set forth in claim 27, step a) further comprising the steps of
g) receiving at least one cable through a first end of the first groove of the substrate; and,
h) receiving at least two cables through a second end of the first groove of the substrate.

29. The method as set forth in claim 28, further comprising the following steps:
i) securing the fiber jackets of the cables received through the first end of the first groove to the substrate at the first end of the first groove using a suitable adhesive;
j) securing the optical fibers of the cables received through the first end of the first groove to the substrate at the first end of the first groove using a suitable material;
k) securing the fiber jackets of the cables received through the second end of the first groove to the substrate at the second end of the first groove using a suitable adhesive; and,
l) securing the optical fibers of the cables received through the second end of the first groove to the substrate at the second end of the first groove using a suitable material.

30. The method as set forth in claim 29, step d) further comprising the steps of:
m) receiving at least one cable through a first end of the second groove of the substrate, the first end of the second groove corresponding to the first end of the first groove, and,
n) receiving at least two cables through a second end of the second groove of the substrate, the second end of the second groove corresponding to the second end of the first groove.

31. The method as set forth in claim 30, further comprising the following steps:
o) securing the fiber jackets of the cables received through the first end of the second groove to the substrate at the first end of the second groove using a suitable adhesive;
p) securing the optical fibers of the cables received through the first end of the second groove to the substrate at the first end of the second groove using a suitable material;
q) securing the fiber jackets of the cables received through the second end of the second groove to the substrate at the second end of the second groove using a suitable adhesive; and,
r) securing the optical fibers of the cables received through the second end of the second groove to the substrate at the second end of the second groove using a suitable material.

32. The method as set forth in claim 31, further comprising the following steps:
s) receiving the lead ends of the cables secured to the first ends of the first and second grooves in a first strain relief member;
t) receiving the lead ends of the cables secured to the second ends of the first and second grooves in a second strain relief member; and,
u) packaging the substrate with the first and second fiber optic couplings in an enclosure adapted to receive the first and second strain relief members with the lead ends of the cables extending through associated strain relief members.

33. The method as set forth in claim 27, further comprising the following steps:
g) receiving at least two fiber optic cables in a third optically isolated groove of the substrate, each cable having a fiber jacket of the cable removed from a middle portion of the cable to expose an optical fiber within the cable;
h) connecting the exposed optical fibers of each cable together in a connecting region of the third groove to form a third fiber optic coupling with at least four coupled fiber optic cables extending therefrom, each coupled fiber optic cable having a connection end joined in the third coupling and a lead end extending outward from the third groove; and
i) selecting at least one of the coupled fiber optic cables from the third coupling and severing the selected coupled fiber optic cable(s) from the third coupling.

34. The method as set forth in claim 33, further comprising the following steps:
j) receiving at least two fiber optic cables in a fourth optically isolated groove of the substrate, each cable having a fiberjacket of the cable removed from a middle portion of the cable to expose an optical fiber within the cable;
k) connecting the exposed optical fibers of each cable together in a connecting region of the fourth groove to form a fourth fiber optic coupling with at least four coupled fiber optic cables extending therefrom, each coupled fiber optic cable having a connection end joined in the fourth coupling and a lead end extending outward from the fourth groove; and
l) selecting at least one of the coupled fiber optic cables from the fourth coupling and severing the selected coupled fiber optic cable(s) from the fourth coupling.

35. A method for assembling a fiber optic device, comprising the steps of
a) receiving at least two fiber optic cables in a first optically isolated groove of a substrate, each cable having a connection end and a lead end, each cable having a fiber jacket removed from the connection end of the cable to expose an optical fiber within the cable, wherein at least one electronic component is disposed in the first groove;
b) connecting the exposed optical fibers from the connection end of each cable to predetermined points on the electronic component(s) in a connecting region of the first groove;
c) receiving at least two fiber optic cables in a second optically isolated groove of the substrate, each cable having a connection end and a lead end, each cable having a fiber jacket removed from the connection end of the cable to expose an optical fiber within the cable, wherein at least one electronic component is disposed in the second groove; and
d) connecting the exposed optical fibers from the connection end of each cable to predetermined points on the electronic component(s) in a connecting region of the second groove.

36. The method as set forth in claim 35, further comprising the following steps:
e) receiving at least two fiber optic cables in a third optically isolated groove of the substrate, each cable having a connection end and a lead end, each cable having a fiber jacket removed from the connection end of the cable to expose an optical fiber within the cable, wherein at least one electronic component is disposed in the third groove; and
f) connecting the exposed optical fibers from the connection end of each cable to predetermined points on the electronic component(s) in a connecting region of the third groove.

37. The method as set forth in claim 36, further comprising the following steps:
g) receiving at least two fiber optic cables in a fourth optically isolated groove of the substrate, each cable having a connection end and a lead end, each cable having a fiber jacket removed from the connection end of the cable to expose an optical fiber within the cable, wherein at least one electronic component is disposed in the fourth groove; and
h) connecting the exposed optical fibers from the connection end of each cable to predetermined points on the electronic component(s) in a connecting region of the fourth groove.
